(19) United States
(12) Patent Application Publication
(10) Pub. No.: US 2021/0072061 A1
(43) Pub. Date: Mar. 11, 2021

(54) COIL TRANSDUCER FOR ELEVATED TEMPERATURES

(71) Applicant: MICRO MOTION, INC., Boulder, CO (US)

(72) Inventors: Mark LUPIENSKI, Superior, CO (US); Robert Barclay GARNETT, Boulder, CO (US)

(73) Assignee: MICRO MOTION, INC., Boulder, CO (US)

(21) Appl. No.: 17/046,223

(22) PCT Filed: May 15, 2018
(86) PCT No.: PCT/US2018/032649

§ 371 Date: Oct. 8, 2020

(51) Int. Cl. G01F 1/84

(52) U.S. Cl. CPC G01F 1/8404; G01F 1/8427; G01F 1/8422

(57) ABSTRACT

A coil transducer (200) for elevated temperatures is provided. The coil transducer (200) includes a coil portion (210) including a coil (212), the coil (212) being comprised of a conductive wire (212a), and an electrical insulator disposed proximate the conductive wire (212a). The coil (212) is configured to have a repeatable electrical property over a temperature range that is greater than 350 C.

### TECHNICAL FIELD

The embodiments described below relate to coil transducers and, more particularly, to a coil transducer for elevated temperatures.

### BACKGROUND

Vibratory meters, such as for example, vibratory densitometers and Coriolis flowmeters are generally known, and are used to measure mass flow and other information for materials flowing through a conduit in the flowmeter. Exemplary Coriolis flowmeters are disclosed in U.S. Pat. Nos. 4,109,524, 4,491,025, and Re. 31,450, all to J. E. Smith et al. These flowmeters have one or more conduits of a straight or curved configuration. Each conduit configuration in a Coriolis mass flowmeter, for example, has a set of natural vibration modes, which may be of simple bending, torsional, or coupled type. Each conduit can be driven to oscillate at a preferred mode by a driver that applies a driving force to the conduit(s).

Material flows into the flowmeter from a connected pipeline on the inlet side of the flowmeter, is directed through the conduit(s), and exits the flowmeter through the outlet side of the flowmeter. The natural vibration modes of the vibrating system are defined in part by the combined mass of the conduits and the material flowing within the conduits.

When there is no-flow through the flowmeter, the driving force applied to the conduit(s) causes all points along the conduit(s) to oscillate with identical phase or a small “zero-flow offset,” which is a time delay measured at zero flow. As material begins to flow through the flowmeter, Coriolis forces cause each point along the conduit(s) to have a different phase. For example, the phase at the inlet end of the flowmeter lags the phase at the centralized driver position, while the phase at the outlet leads the phase at the centralized driver position. Pickoffs on the conduit(s) produce sinusoidal signals representative of the motion of the conduit(s). Signals output from the pickoffs are processed to determine the time delay between the pickoffs. The time delay between the two or more pickoffs is proportional to the mass flow rate of material flowing through the conduit(s). The signals output from the pickoffs can also be compared to a drive signal provided to the driver for meter verification where conditions, such as coatings, cracks, erosions, or the like, in the conduit(s) are detected.

The driver and pickoffs may be comprised of a coil transducer. The coil transducer may convert electrical energy in the coil into a mechanical movement and therefore be the driver described above. The coil transducer may also convert mechanical movement into electrical energy and therefore be the pickoffs described above. As a result, a quantitative relationship between the mechanical movement (e.g., vibration of the conduit(s)) and the electrical energy may depend on an electrical property of a component in the coil transducer.

The electrical properties of the coil transducer can vary but be repeatable with respect to temperature. For example, the resistance of a coil in the coil transducer may always be about a given value when the coil is 100° C. Accordingly, electronics in the vibratory meter can compensate for variations in the temperature of the coil. However, at elevated temperatures (e.g., greater than 350° C.) the electrical properties may not be repeatable for various reasons. For example, some insulators may behave as conductors at temperatures greater than 350° C. As a result, non-repeatable variations in the electrical properties of the components can cause, for example, the zero-flow offset to vary, meter verification results to be inaccurate, etc. As a result, there is a need for a coil transducer for elevated temperatures.

### SUMMARY

A coil transducer for elevated temperatures is provided. According to an embodiment, the coil transducer comprises a coil portion including a coil, the coil being comprised of a conductive wire, and an electrical insulator disposed proximate the conductive wire. The coil is configured to have a repeatable electrical property over a temperature range that is greater than 350° C.

A method of forming a coil transducer for elevated temperatures is provided. According to an embodiment, the method comprises forming a coil portion including a coil, the coil being comprised of a conductive wire, disposing an electrical insulator proximate the conductive wire, and configuring the coil to have a repeatable electrical property over a temperature range that is greater than 350° C.

A vibratory meter for elevated temperatures is provided. According to an embodiment, the vibratory meter comprises a meter electronics and a meter assembly communicatively coupled to the meter electronics. The meter assembly comprises at least one conduit, a driver coupled to the at least one conduit, and at least one pickoff coupled to the at least one conduit. At least one of the driver and the at least one pickoff comprise a coil transducer. The coil transducer comprises a coil portion including a coil. The coil is comprised of a conductive wire, and an electrical insulator disposed proximate the conductive wire. The coil is configured to have a repeatable electrical property over a temperature range that is greater than 350° C.

### ASPECTS

According to an aspect, a coil transducer (200) for elevated temperatures comprises a coil portion (210) including a coil (212), the coil (212) being comprised of a conductive wire (212a), and an electrical insulator disposed proximate the conductive wire (212a). The coil (212) is configured to have a repeatable electrical property over a temperature range that is greater than 350° C.

Preferably, the coil (212) being configured to have the repeatable electrical property over the temperature range that is greater than 350° C. comprises at least one of the conductive wire (212a) and the electrical insulator being thermal-expansion compatibles of each other over the temperature range, the electrical insulator being substantially non-conductive over the temperature range, and the conductive wire (212a) having a substantially repeatable conductivity over the temperature range.

Preferably, the conductive wire (212a) and the electrical insulator being thermal-expansion compatibles of each other comprises the conductive wire (212a) and the electrical insulator having substantially equal coefficients of thermal expansion.

Preferably, the conductive wire (212a) having a substantially repeatable conductivity over the temperature range comprises the conductive wire (212a) having a substantially repeatable conductivity over a plurality of temperature cycles including at least a portion of the temperature range.

Preferably, each of the plurality of temperature cycles includes the temperature range.

Preferably, the electrical insulator comprises a ceramic coating (212b) on the conductive wire (212a).

Preferably, the electrical insulator comprises a bobbin (214), and the coil (212) is disposed around the bobbin (214).

Preferably, the conductive wire (212a) and at least one of the bobbin (214) and the ceramic coating (212b) are thermal-expansion compatibles of each other.

Preferably, the conductive wire (212a) comprises a magnetic material.

Preferably, the conductive wire (212a) comprises a material that includes one of nickel, a nickel alloy, a platinum-rhodium alloy, a platinum-iridium alloy, and a niobium-tantalum-tungsten alloy.

Preferably, the temperature range is one of from 350° C. to 500° C., from 350° C. to 427° C., from 410° C. to 500° C., and from 410° C. to 427° C.

Preferably, the coil transducer (200) further comprises a magnet portion (220), the magnet portion (220) being configured to spatially displace relative to the coil portion (210).

According to an aspect, a method of forming a coil transducer for elevated temperatures comprises forming a coil portion including a coil, the coil being comprised of a conductive wire, disposing an electrical insulator proximate the conductive wire, and configuring the coil to have a repeatable electrical property over a temperature range that is greater than 350° C.

Preferably, configuring the coil to have the repeatable electrical property over the temperature range that is greater than 350° C. comprises at least one of configuring the conductive wire and the electrical insulator to be thermal-expansion compatibles of each other over the temperature range, configuring the electrical insulator to be substantially non-conductive over the temperature range, and configuring the conductive wire to have a substantially repeatable conductivity over the temperature range.

Preferably, configuring the conductive wire and the electrical insulator to be thermal-expansion compatibles of each other comprises configuring the conductive wire and the electrical insulator to have substantially equal coefficients of thermal expansion.

Preferably, configuring the conductive wire to have a substantially repeatable conductivity over the temperature range comprises configuring the conductive wire to have a substantially repeatable conductivity over a plurality of temperature cycles including at least a portion of the temperature range.

Preferably, each of the plurality of temperature cycles includes the temperature range.

Preferably, disposing the electrical insulator proximate the conductive wire comprises disposing a ceramic coating on the conductive wire.

Preferably, disposing the electrical insulator proximate the conductive wire comprises forming a bobbin and disposing the coil around the bobbin.

Preferably, configuring the conductive wire and the electrical insulator to be thermal-expansion compatibles of each other comprises configuring the conductive wire and at least one of the bobbin and the ceramic coating to be thermal-expansion compatibles of each other.

Preferably, the conductive wire comprises a magnetic material.

Preferably, the conductive wire comprises a material that includes one of nickel, a nickel alloy, a platinum-rhodium alloy, a platinum-iridium alloy, and a niobium-tantalum-tungsten alloy.

Preferably, the temperature range is one of from 350° C. to 500° C., from 350° C. to 427° C., from 410° C. to 500° C., and from 410° C. to 427° C.

Preferably, the method further comprises forming a magnet portion and configuring the magnet portion to spatially displace relative to the coil portion.

According to an aspect, a vibratory meter (5) for elevated temperatures comprises a meter electronics (20), and a meter assembly (10) communicatively coupled to the meter electronics (20). The meter assembly (10) comprises at least one conduit (103A, 103B), a driver (104) coupled to the at least one conduit (103A, 103B), and at least one pickoff (105, 105′) coupled to the at least one conduit (103A, 103B). At least one of the driver (104) and the at least one pickoff (105, 105′) comprise a coil transducer (200). The coil transducer (200) comprises a coil portion (210) including a coil (212), the coil (212) being comprised of a conductive wire (212a), and an electrical insulator disposed proximate the conductive wire (212a). The coil (212) is configured to have a repeatable electrical property over a temperature range that is greater than 350° C.

Preferably, the coil (212) being configured to have the repeatable electrical property over the temperature range that is greater than 350° C. comprises at least one of the conductive wire (212a) and the electrical insulator being thermal-expansion compatibles of each other over the temperature range, the electrical insulator being substantially non-conductive over the temperature range, and the conductive wire (212a) having a substantially repeatable conductivity over the temperature range.

### BRIEF DESCRIPTION OF THE DRAWINGS

The same reference number represents the same element on all drawings. It should be understood that the drawings are not necessarily to scale.

FIG. 1 shows a vibratory meter 5, including a coil transducer for elevated temperatures, in the form of a Coriolis flow meter.

FIG. 2 shows a cross-sectional view of a coil transducer 200 for high temperature environments.

FIG. 3 shows a detailed cross-sectional view of the coil transducer 200 shown in FIG. 2.

FIG. 4 shows a graph 400 illustrating how an elevated temperature can affect a mass flow rate measurement.

FIG. 5 shows a graph 500 illustrating stable mass flow rate measurements resulting from a coil transducer for elevated temperatures.

FIG. 6 shows a graph 600 illustrating a failure during temperature cycling.

FIG. 7 shows a graph 700 illustrating resistance measurements resulting from a coil transducer for elevated temperatures.

FIG. 8 shows a graph 800 illustrating electrical properties of a coil transducer for elevated temperatures.

FIG. 9 shows a graph 900 illustrating stable mass flow rate measurements resulting from a coil transducer for elevated temperatures.

FIG. 10 shows a method 1000 of forming a coil transducer for elevated temperatures.

### DETAILED DESCRIPTION

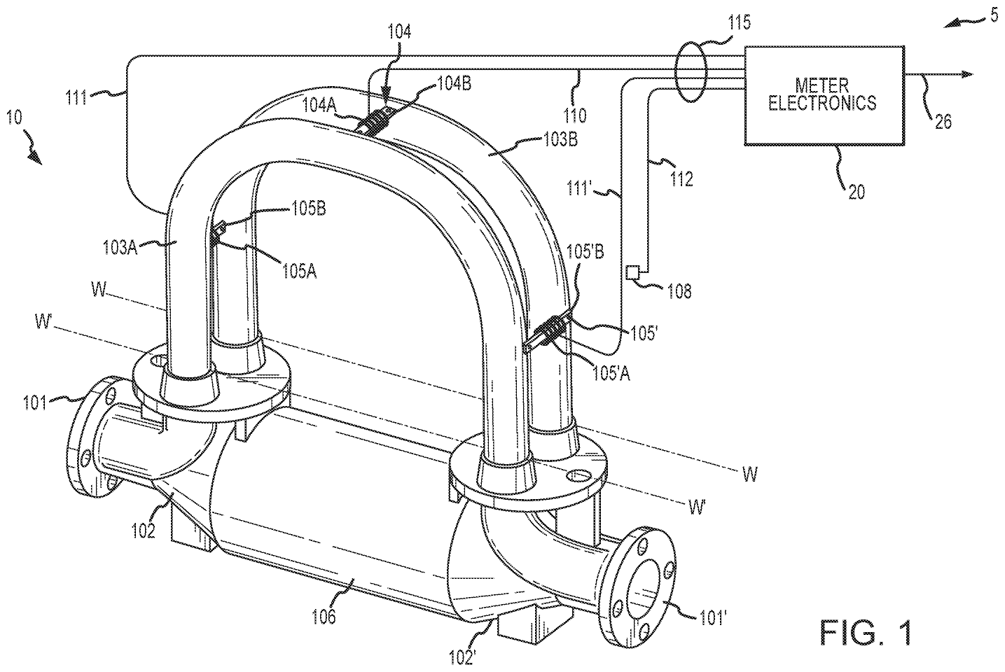

FIGS. 1-10 and the following description depict specific examples to teach those skilled in the art how to make and use the best mode of embodiments of a coil transducer for elevated temperatures. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the coil transducer for elevated temperatures. As a result, the embodiments described below are not limited to the specific examples described below, but only by the claims and their equivalents.

FIG. 1 shows a vibratory meter 5, including a coil transducer for elevated temperatures, in the form of a Coriolis flow meter. As shown in FIG. 1, the vibratory meter 5 comprises a meter assembly 10 and a meter electronics 20. The meter electronics 20 is in electrical communication with the meter assembly 10 to measure characteristics of a flowing material, such as, for example, density, mass flow rate, volume flow rate, totalized mass flow, temperature, and other information.

The meter assembly 10 includes a pair of flanges 101 and 101′, manifolds 102 and 102′, and a first and second conduit 103A, 103B. Manifolds 102, 102′ are affixed to opposing ends of the first and second conduit 103A, 103B. Flanges 101 and 101′ of the prior art Coriolis flow meter are affixed to opposite ends of the spacer 106. The spacer 106 maintains the spacing between manifolds 102, 102′ to prevent undesired vibrations in the first and second conduit 103A, 103B. The first and second conduit 103A, 103B extend outwardly from the manifolds in an essentially parallel fashion. When the meter assembly 10 is inserted into a pipeline system (not shown) which carries the flowing material, the material enters meter assembly 10 through flange 101, passes through the inlet manifold 102 where the total amount of material is directed to enter the first and second conduit 103A, 103B, flows through the first and second conduit 103A, 103B and back into the outlet manifold 102′ where it exits the meter assembly 10 through the flange 101′.

The meter assembly 10 includes a driver 104. The driver 104 is affixed to the first and second conduit 103A, 103B in a position where the driver 104 can vibrate the conduits 103A, 103B in the drive mode, for example. More particularly, the driver 104 includes a first driver component 104A affixed to the first conduit 103A and a second driver component 104B affixed to the second conduit 103B. The driver 104 may comprise one of many well-known arrangements such as a coil mounted to the first conduit 103A and an opposing magnet mounted to the second conduit 103B.

The drive mode is the first out of phase bending mode and the first and second conduits 103A, 103B are selected and appropriately mounted to inlet manifold 102 and outlet manifold 102′ so as to provide a balanced system having substantially the same mass distribution, moments of inertia, and elastic modulus about bending axes W-W and W′-W′, respectively. In the present example, where the drive mode is the first out of phase bending mode, the first and second conduits 103A, 103B are driven by the driver 104 in opposite directions about their respective bending axes W-W and W′-W′. A drive signal 110 in the form of an alternating current can be provided by the meter electronics 20, and passed through the coil to cause both the first and second conduit 103A, 103B to oscillate. Additionally or alternatively, other drive modes may be used by the vibratory meter.

The meter assembly 10 shown includes a pair of pickoffs 105, 105′ that are affixed to the conduits 103A, 103B. More particularly, first pickoff components 105A and 105′A are located on the first conduit 103A and second pickoff components 105B and 105′B are located on the second conduit 103B. In the example depicted, the pickoffs 105, 105′ may be coil transducers, for example, pickoff magnets and pickoff coils that produce pickoff signals that represent the velocity and position of the first and second conduit 103A, 103B. For example, the pickoffs 105, 105′ may supply pickoff signals 111, 111′ to the meter electronics 20. Those of ordinary skill in the art will appreciate that the movements of the first and second conduit 103A, 103B are generally proportional to certain characteristics of the flowing material, for example, the mass flow rate and the density of the material flowing through the first and second conduit 103A, 103B. However, the motion of the first and second conduit 103A, 103B also includes a zero-flow offset that can be measured at the pickoffs 105, 105′. The zero-flow offset can be caused by a number of factors such as non-proportional damping, residual flexibility response, electromagnetic crosstalk, or phase delay in instrumentation.

In many vibratory meters, the zero-flow offset is typically corrected for by measuring the zero-flow offset at zero-flow conditions and subtracting the measured zero-flow offset from subsequent measurements made during flow. While this approach provides an adequate flow measurement when the zero-flow offset remains constant, in actuality the zero-flow offset changes due to a variety of factors, including changes in the ambient environment (such as temperature) or changes in the conduit(s) through which the material is flowing. To measure the temperature, a temperature sensor 108 may be disposed proximate to the meter assembly 10, in particular, the first and second conduit 103A, 103B. The temperature sensor 108 may be any suitable temperature sensor, such as a resistive temperature detector, infrared sensor, or the like. The temperature sensor 108 may be coupled, directly or indirectly, to any portion of the meter assembly 10, a case surrounding the meter assembly 10, etc.

It should be appreciated that while the meter assembly 10 described above comprises a dual conduit vibratory meter, it is well within the scope of the present invention to implement a single conduit vibratory meter. Furthermore, while the first and second conduit 103A, 103B are shown as comprising a curved conduit configuration, the present invention may be implemented with a vibratory meter comprising a straight conduit configuration. Therefore, the particular embodiment of the meter assembly 10 described above is merely one example and should in no way limit the scope of the present disclosure.

In the example shown in FIG. 1, the meter electronics 20 provides the drive signal 110 to the driver 104 and receives the left and right pickoff signals 111, 111′ from the pickoffs 105, 105′. The meter electronics 20 also receives a temperature signal 112 from the temperature sensor 108. The drive signal 110, left and right pickoff signal 111, 111′, and temperature signal 112 are collectively referred to as sensor signals 115. The meter electronics 20 can process the sensor signals 115 to determine, for example, a mass flow rate, density, or the like of a material in the conduits 103A, 103B. The meter electronics 20 can also process the sensor signals 115 to perform meter verification of the meter assembly 10. Path 26 provides an input and an output means that allows one or more meter electronics 20 to interface with an operator.

As discussed above, the zero-flow offset can be compensated for by measuring an initial zero-flow offset Δt₀ during an initial calibration process, which usually involves closing valves and providing a zero flow condition to a vibratory meter. During operation, flow measurements are adjusted by subtracting the initial zero-flow offset Δt₀ from the measured time difference according to Equation [1].

\dot{m}=FCF(Δt_{measured}−Δt₀) [1]

Where:
\dot{m}=mass flow rate
FCF=Flow calibration factor
Δt_{measured}=measured time delay
Δt₀=initial zero-flow offset
   It should be appreciated that Equation [1] is merely provided as an example and should in no way limit the scope of the present disclosure. As can be appreciated, the zero-flow offset changes can result in a measurement error of the flow characteristics.

The zero-flow offset changes may only be present at elevated temperatures, such as temperatures over 350° C. The zero-flow offset changes may be due to non-repeatable electrical properties of pickoffs in prior art vibratory meters. For example, a conductive wire of the pickoffs in a prior art vibratory meter may experience mechanical creep due to mechanical stresses that are present when the pickoffs are at the elevated temperatures. Due to the mechanical creep, the resistance of the conductive wire may increase over time, or the conductive wire may simply break. As a result, the resistance of the conductive wire is not repeatable over an elevated temperature range. Additionally or alternatively, a ceramic coating on the conductive wire, or other electrical insulators, may conduct at the elevated temperatures. This can lead to current leakage from the conductive wire of the pickoffs in the vibratory meter.

The mechanical stresses in the conductive wire may be due to the thermal expansion of the components in the pickoffs at the elevated temperatures. For example, the materials of the components may have different or incompatible coefficients of thermal expansion, thereby causing proximate (e.g., abutting, adjacent, etc.) components to expand at different rates. For example, the conductive wire may have a ceramic coating that expands at a different rate than the conductive wire. This difference may not cause significant mechanical stresses on the conductive wire at temperatures less than 350° C. However, at temperatures greater than 350° C., the ceramic coating may not have expanded as much as the conductive wire, thereby causing a mechanical stress in the conductive wire. Similarly, a bobbin about which the conductive wire is wrapped may also cause the mechanical stresses in the conductive wire.

As can be appreciated from the foregoing discussion, the electrical properties of the pickoffs may be non-repeatable only after the pickoffs are at the elevated temperature for some time. That is, the electrical properties may, for example, have a repeatable nominal value at a given temperature when the temperature is increased from, for example, room temperature to over 350° C. However, the electrical properties may begin to deviate from the nominal value after the pickoff remains at the elevated temperature for a period of time. For example, as discussed above, the conductive wire in the pickoff may experience mechanical creep due to the elevated temperature. Accordingly, the electrical properties may remain substantially repeatable (e.g., may remain within a specified range of the nominal value) until sufficient time has passed such that the creep causes a significant change in mechanical properties (e.g., fatigue sufficient to change the electrical resistance) or dimensions (e.g., change in the cross sectional area) of the coil. These changes may also occur due to temperature cycling of the pickoffs. For example, fatigue may only be present due to the temperature cycling over a period of time.

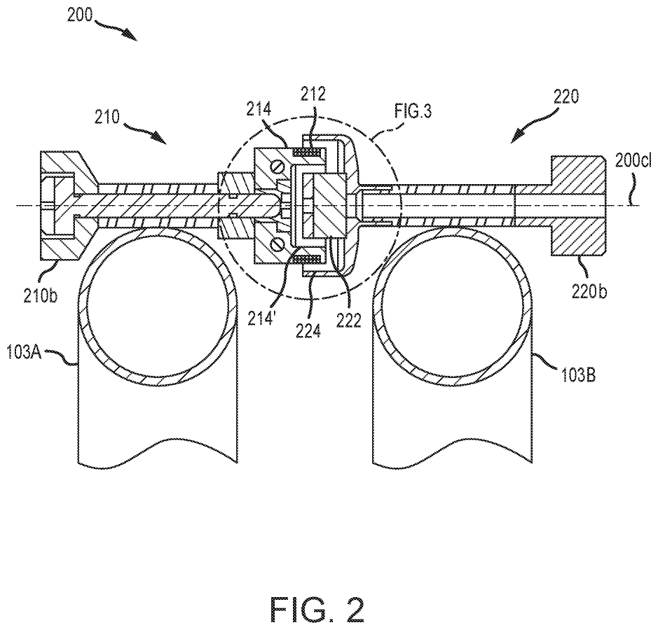

FIG. 2 shows a cross-sectional view of a coil transducer 200 for high temperature environments. The coil transducer 200 may be one of the pickoffs 105, 105′ or the driver 104 described above, although the coil transducer may be employed in or on any assembly that imposes and/or senses a movement, such as a vibration, at the elevated temperatures. For example, the coil transducer 200 may be employed in a densitometer. As shown in FIG. 2, the coil transducer 200 is comprised of a coil portion 210 and a magnet portion 220. The coil portion 210 and the magnet portion 220, as well as their components, are shown as being aligned along a coil transducer centerline 200cl.

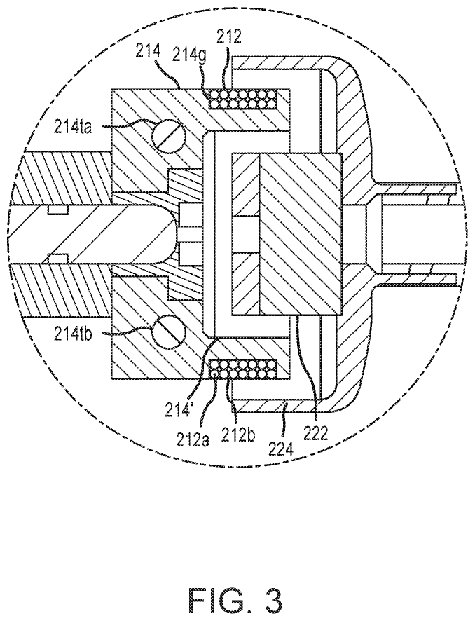

As shown in FIG. 2, the coil portion 210 is coupled to the first conduit 103A with the mounting bracket 210b. The mounting bracket 210b may be coupled to the first conduit 103A according to techniques such as welding, brazing, bonding, etc. The coil portion 210 includes a coil 212, which is described in more detail in the following with reference to FIG. 3. The coil portion 210 also comprises a bobbin 214. The bobbin 214 can include a magnet receiving portion 214′. The bobbin 214 can be held onto the mounting bracket 210b with a bolt or similar fastening device. The particular method used to couple the coil portion 210 to the first conduit 103A should in no way limit the scope of the present embodiment.

The magnet portion 220 comprises a magnet 222 that is held onto the mounting bracket 220b using a bolt. The magnet 222 can be positioned within a magnet keeper 224 that can help direct the magnetic field. The mounting bracket 220b is shown coupled to the second conduit 103B. The mounting bracket 220b may be coupled to the second conduit 103B according to techniques such as welding, brazing, bonding, etc.

Additionally, while the coil transducer 200 is shown being coupled to the first and second conduit 103A, 103B, in other embodiments, the coil portion 210 and/or the magnet portion 220 may be coupled to a stationary component or a dummy tube, for example. This may be the case in situations where the coil transducer 200 is utilized in a single conduit meter assembly.

FIG. 3 shows a detailed cross-sectional view of the coil transducer 200 shown in FIG. 2. As shown in the detailed cross-sectional view of FIG. 3, the coil 212 includes a conductive wire 212a and a ceramic coating 212b. The ceramic coating 212b is deposited on the conductive wire 212a. The coil 212 is disposed around the bobbin 214.

The conductive wire 212a and the bobbin 214 are electrical insulators disposed proximate the conductive wire 212a. As shown in FIG. 3, the coil 212 is disposed in a groove 214g of the bobbin. The groove 214g is circumferential about the bobbin 214 and has a rectangular cross section, although any suitable shape, cross-section, or the like, may be employed. Each end of the conductive wire 212a is electrically coupled (e.g., bonding, brazing, intervening bus, screw-terminal junction, etc.) to a first terminal 214ta and a second terminal 214tb. As can also be seen, the magnet 222 is partially disposed in the magnet receiving portion 214′. The magnet 222 is disposed in and affixed to the magnet keeper 224.

With reference to FIGS. 2 and 3, the coil transducer 200 is an electrical-mechanical transducer. Due to the motions of the conduits 103A, 103B, the magnet 222 and the coil 212 moves along the coil transducer centerline 200cl such that the magnet 222 moves relative to the coil 212. This movement induces an electrical signal that is proportional to a displacement, velocity, acceleration, or the like, of the magnet 222 relative to the coil 212. Additionally, a signal provided to the coil 212 can act on the magnet 222 to cause a force, which in turn, can cause the conduits 103A, 103B to proportionally move. As shown, the movement is substantially linear even though the first and second conduits 103A, 103B bend about an axis.

As can be appreciated, a quantitative relationship between the relative movement of the coil 212 and the magnet 222, and the signal in the coil 212 depends on the electrical properties of the coil 212. For example, as temperature increases, the resistance of the conductive wire 212a may correspondingly increase. Additionally or alternatively, the electrical properties of the ceramic coating 212b on the conductive wire 212a may also vary with increasing temperature. If these electrical properties are repeatable relative to the temperature, then, for example, the meter electronics 20 can correlate the signal in the coil 212 to the movement. As can be appreciated from the above discussion, this means that the zero-flow offset may remain the same as an initial zero-flow offset Δt₀.

However, if the electrical properties are not repeatable relative to the temperature of a coil transducer, then zero-flow offset changes may cause inaccurate mass flow rate measurements. As will be explained in the following, the coil transducer 200 of FIGS. 2 and 3 is comprised of components that can be used at the elevated temperatures to accurately measure a mass flow rate.

### Conductive Wire

The following Table 1 shows properties of various conductive wire materials that may be employed in the coil transducer 200 for elevated temperatures as well as materials that may not be suitable for the elevated temperatures. Table 1 includes a material column listing various materials. Associated with each material are columns of density, ultimate strength, coefficient of thermal expansion (CTE), and operating limit values. Standard units are employed, although any suitable unit can be used to evaluate conductive wires.

TABLE 1
Comparison of properties of various conductive wire materials

| | | Ulti- | | | | |
|---|---|---|---|---|---|---|
| | ρ | mate | Yield | CTE | Operating | |
| | (μΩcm²/ | Strength | Strength | (μin/in/ | Limit | |
| Material | cm) | (ksi) | (ksi) | ° C.) | (° C.) | |
| Ag | 1.59 | 18.0 | 7.9 | 19.7 | 450 | (est.) |
| | | | | | 430+ | (3 cycles) |
| Ni | 9.48 | 50.0 | 13.1 | 13.3 | 500+ | (est.) |
| Pt | 10.6 | 18.1 | 2.0 | 9.1 | 410 | (est.) |
| Pt—Rh | 19.2 | 45.0 | 19.6 | 8.9 | 440 | (est.) |
| (90-10) | | | | | | |
| Pt—Rh | 20.8 | 70.3 | 38.4 | 8.9 | 450 | (est.) |
| (80-20) | | | | | 430+ | |
| Pt—Ir | | 55.1 | 26.8 | 8.8 | 420 | (est.) |
| (90-10) | | | | | | |
| Pt—Ir | 31.0 | 100.0 | 59.5 | 8.6 | 430 | (est.) |
| (80-20) | | | | | | |
| Nb—Ta—W | 10.0 | 66.0 | 50.0 | 7.8 | 500+ | (est.) |
| (80-10-10) | | | | | | |
| Nb—Zr | — | 35.0 | 15.0 | — | — | |
| (99-1) | | | | | | |
| Ta | 12.5 | 30.0 | 24.0 | 6.5 | 500+ | (est.) |
| Kovar | 49.0 | 75.0 | 50.0 | 5.86 | 500+ | (est.) |
| Mo | 5.15 | 100.0 | 55.0 | 5.4 | 200 | (est.) |
| W | 5.49 | 250.0 | 65.3 | 4.6 | 100 | (est.) |
| Cu | 1.71 | 30.0 | 15.0 | 16.6 | 300 | (est.) |

The materials are listed by their periodic table symbol or symbols, or trade names. For example, the materials in the material column include silver (Ag), nickel (Ni), platinum (Pt), tantalum (Ta), molybdenum (Mo), and tungsten (W) elements. Also shown are platinum-rhodium (Pt—Rh at 80-20 composition), platinum-iridium (Pt—Ir at 80-20 composition), and niobium-tantalum-tungsten (Nb—Ta—W at 80-10-10 composition) alloys. The composition is the proportions of each element corresponding to each number in the composition. For example, the composition Pt—Ir at 80-20 means that an alloy is comprised of eighty percent platinum and twenty percent iridium. The composition is in units of mass, although any suitable units may be employed. Therefore, a hundred kilograms of Pt—Ir at 80-20 alloy may have 80 kilograms of platinum and 20 kilograms of iridium. Also shown is the tradename of “Kovar,” which is a nickel alloy, in particular, a nickel-cobalt alloy.

As can be seen in Table 1, the CTE of the wire conductors differ. For example, silver Ag has a CTE of 19.7 μin/in/° C. This means that, for every inch of material, the silver Ag will expand in a direction 19.7 μin for every degree Celsius temperature increase. By way of comparison, the tungsten has a CTE of 4.6 μin/in/° C. As can be appreciated, this difference may be significant, depending on a length of the conductive wire. For example, if a one thousand foot (12,000 inches) silver conductive wire is heated from room temperature to 500° C., the lineal length of the conductive wire may increase by about 113 inches. A tungsten conductive wire of the same length, and subjected to the same temperature increase, may increase by about 26 inches.

The operating limit of the materials may be estimated from a literature review (indicated by the “(est.)”) or quantitatively established by testing. For example, platinum's operating limit of 410° C. may be estimated from literature review. The literature review may indicate that the tensile strength of platinum is significantly less at temperatures of 410° C. Accordingly, although platinum may be able to conduct electricity and elastically deform at temperatures over 410° C., a platinum conductive wire may have, for example, substantially non-repeatable conductivity over a temperature range greater than 410° C. Therefore, the literature review may indicate that the platinum conductive cannot be used at temperatures over 410° C. to obtain accurate measurements in a vibratory meter.

Some of the operating limits may be estimated up to 500° C. due to, for example, repeatable electrical properties, such as repeatable conductivity that do not have significant deviations from a nominal value over the temperature range. Accordingly, since the electrical properties are repeatable up to 500° C., the plus sign is used. By way of example, literature review may indicate that a conductive wire comprised of a niobium-tantalum-tungsten alloy can be used in a Coriolis flow meter rated to 500° C.

However, the operating limit may also be established as a result of testing of the conductive wire over the elevated temperature range. For example, the operating limit of the platinum-rhodium alloy is established up to 430° C. The operating limit may be established by testing a conductive wire with an electrical insulator that is proximate the wire.

### Electrical Insulators

The electrical insulator may be any suitable material, such as, for example, a ceramic, polymer, composite material, etc. For example, the electrical insulator may be comprised of a glass-ceramic (e.g., tradename Macor developed by Corning), which may or may not be machine-able, a cement (e.g., Electrotemp cement no. 8 developed by Sauereisen), a ceramic coating (e.g., tradename Ceramacoat 512-N developed by Aremco), etc. In the above examples of an electrical insulator, Macor has a CTE of 9.3 μin/in/° C., Sauereisen #8 has a CTE of 4.7 μin/in/° C., and Aremco 512N has a CTE of 9.9 μin/in/° C. These above exemplary electrical insulators all have operating limits of at least 500° C. That is, they consistently operate as electrical insulators from room temperature to at least 500° C. The present disclosure is not limited to these particular electrical insulators.

However, some electrical insulators have an operating limit that is less than 500° C. For example, some ceramic materials that include metal components (e.g., to improve bonding) may conduct current at over 350° C. The amount of current conducted by the ceramic material that includes the metal components may be insignificant in many applications, but may be significant in vibratory meters. For example, the current leakage by such a ceramic coating in a coil transducer in a Coriolis flow meter may cause zero-flow offset drifts at elevated temperatures, thereby causing inaccurate mass flow rate measurements.

### CTE Comparisons

As discussed above, the thermal expansions of the conductive wire and/or the electrical insulator may cause mechanical stress on the conductive wire. As a result, the electrical properties of the conductive wire may vary or not repeat over a temperature range. This mechanical stress may be reduced or eliminated in various ways, including selecting materials for the conductive wire and the electrical insulator that have substantially the same CTE. For example, by referring to the exemplary conductive wires and electrical insulators discussed above, it may be determined that Macor, Aremco 512N, and the platinum-rhodium alloy have approximately the same CTE. Accordingly, a coil transducer comprised of these materials may have an operating limit that meets the specifications of a given vibratory meter, as is explained below in more detail.

### Thermal Expansion Compatibility

Thermal-expansion compatible components do not adversely affect electrical properties of each other when subjected to the elevated temperatures. Accordingly, the components can be parts of a coil transducer in a vibratory meter for the elevated temperatures. Whether Macor, Aremco 512N, and the platinum-rhodium alloy will be thermal expansion compatible in a given vibratory meter depends not only on the material selection, but also the design (e.g., shape, dimensions, cross-sectional profiles, winding methods, assembly methods, etc.) of the components in the coil transducer determines whether they are thermal-expansion compatibles of each other. For example, it may be determined that, for example, even though platinum has a CTE that is close to the CTE of Macor, this closeness may be a disadvantage where the coil is wrapped around a given Macor bobbin design at a given tension. Accordingly, selecting the platinum-rhodium alloy as a material for the given Macor bobbin design may be advantageous, along with the other advantages of the material (e.g., the tensile strength of the platinum-rhodium alloy is significantly higher than platinum).

By way of example, a Macor bobbin may be specified to have a cylindrical shape having an outside diameter of 0.830 inches and a circumferential groove having a diameter of 0.708 inches. The bobbin may also have a coaxial bore having an internal diameter of about 0.628 inches. For these specifications, where a conductive wire is wrapped around the bobbin in the circumferential groove, platinum may not have an operating limit of up to the 410° C., but, instead, may be limited to 350° C. This may be due to the tension in the conductive wire after the conductive wire is wrapped around the bobbin. In contrast, the conductive wire comprised of platinum-rhodium alloy having a diameter of 0.0050 inches and a length of about 33 feet may, after literature review, have an estimated operating limit of up to 500° C. because, for example, mechanical creep may not be present up to 500° C. Other dimensions may be employed and still achieve this operating limit, such as, for example, and not limited to, diameters from 0.0025-0.0050 inches and/or lengths other than 33 feet. As discussed above, the effective operating limit may be established through simulations, testing processes, or the like, of the various combinations of materials and component design. An exemplary testing process is described below in more detail.

### Exemplary Testing Process

As discussed above, the effective operating limit of a given material may be established by electrical testing at elevated temperature, or over a plurality of temperature cycles that include the elevated temperature ranges. The operating limit of the conductive wire and/or the insulating material may be determined by using a formed sample of the material (e.g., a conductive wire assembled into a coil, machined electrical insulator, deposited and baked ceramic, etc.), an assembled coil transducer, and/or a coil transducer assembled into a vibratory meter.

The conductive wire and/or electrical insulator of each of the above materials may be assembled into a coil or coil transducer, placed into an oven, and/or subjected to temperature cycles while measuring an electrical property of the conductive wire and/or the electrical insulator. The electrical property may include, but is not limited to, a conductivity and a resistance of the conductive wire and the electrical insulator. The temperature cycles may range from room temperature (e.g., 23° C.) up to 500° C., although any suitable range may be employed, including those less than room temperature and greater than 500° C. Additionally or alternatively, the coil transducers comprising a conductive wire and/or electrical insulators may be assembled into a vibratory meter, such as, for example, the vibratory meter 5 described above, which is placed into the oven.

The conductivity or resistance of the conductive wires and electrical insulator may be measured during the temperature cycles to determine if, for example, the conductivity is repeatable (e.g., resistance v. temperature is repeatable over the elevated temperature range). For example, the measured electrical property remains within a specified range of a nominal value for a given temperature. In the case of the electrical insulators, the nominal value may be zero conductivity for the entire temperature range. For the conductive wire, the measured conductivity or resistance may be within the specified range of a nominal value corresponding to a temperature value over the elevated temperature range. Additionally or alternatively, the coil, coil transducer, and/or vibratory meter may be subjected to temperature cycles while the vibratory meter measures, for example, a zero-flow condition or a known mass flow rate to determine if the vibratory meter is accurately measuring the zero or known mass flow rates.

Accordingly, the coil transducer having the coil configured to have a repeatable electrical property over the predetermined temperature range may be provided. As a result, for example, more accurate mass flow rate measurements may be obtained. The following figures illustrate improvements that may be provided by the coil transducer 200 shown in FIGS. 2 and 3.

### Exemplary Testing

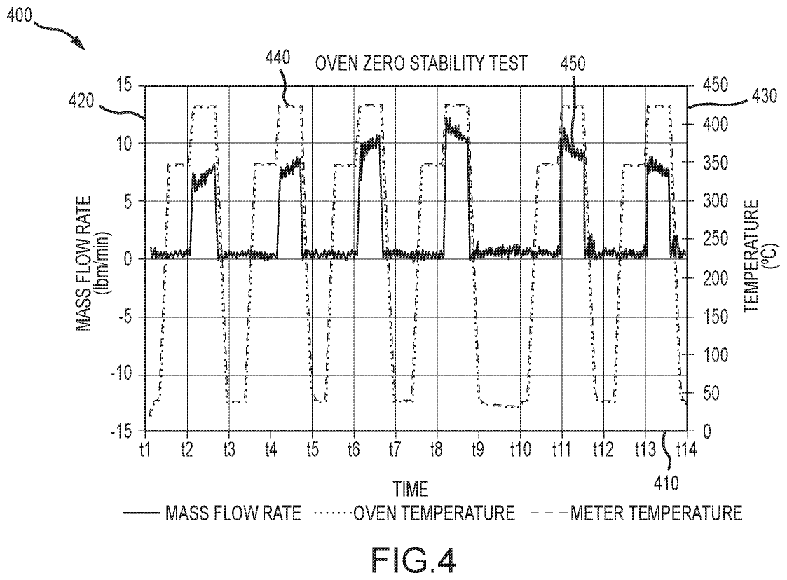

FIG. 4 shows a graph 400 illustrating how an elevated temperature can affect a mass flow rate measurement. As shown in FIG. 4, the graph 400 includes a time axis 410, a mass flow rate axis 420, and a temperature axis 430. The time axis 410 is shown in units of time, the mass flow rate axis 420 is shown as being in units of pound-mass per minute (lbm/min), and the temperature axis 430 is shown in units of degrees Celsius (° C.), although any suitable units may be employed. The time axis 410 is shown as ranging from t1 to t14, which may span weeks, although any suitable time ranges may be employed.

The graph 400 includes temperature plots 440 (comprising oven temperature and meter temperature measurements) and a mass flow rate plot 450. The temperature plots 440 are shown as ranging from about 25° C. to about 430° C., although any suitable range may be employed, including temperature less than 20° C. and greater than 430° C. The mass flow rate plot 450 is shown as ranging from about 0 to about 13 lbm/min. The mass flow rate plot 450 is obtained by measuring a mass flow rate of a vibratory meter under zero-flow conditions. By comparing the temperature plots 440 and the mass flow rate plot 450, one can appreciate that the mass flow rate plot 450 increases significantly when the temperature increases.

With more particularity, the mass flow rate plot 450 is stable at near zero lbm/min when the temperature ranges from about 20° C. to about 350° C. However, when the temperature plots 440 increases from 350° C. to 430° C., the mass flow rate plot 450 shows a significant increase in measured mass flow rate. This increase in measured flow rate is not due to an increase in an actual mass flow rate through a vibratory meter. Instead, the increase in flow rate is due to measured zero-flow offset instability due to the temperature increase.

The pickoff sensors of the vibratory meter tested to generate the mass flow rate plot 450 may have been comprised of, for example, nickel conductive wire and a ceramic that includes a metal infused ceramic bobbin. The increase in mass flow rate may have been due to the metal infused ceramic bobbin conducting electricity above 350° C.

As can be appreciated, the mass flow rate plot 450 indicates that the electrical properties of the bobbin and the coil in the pickoff sensors are likely repeatable over the temperature range of 25 to about 350° C. However, the mass flow rate plot 450 also shows that the electrical properties of the pickoff sensors are not repeatable over the temperature range of 350° C. to 430° C. As a result, the materials used in the pickoff sensors may not be suitable for vibratory meters specified to operate at over 350° C.

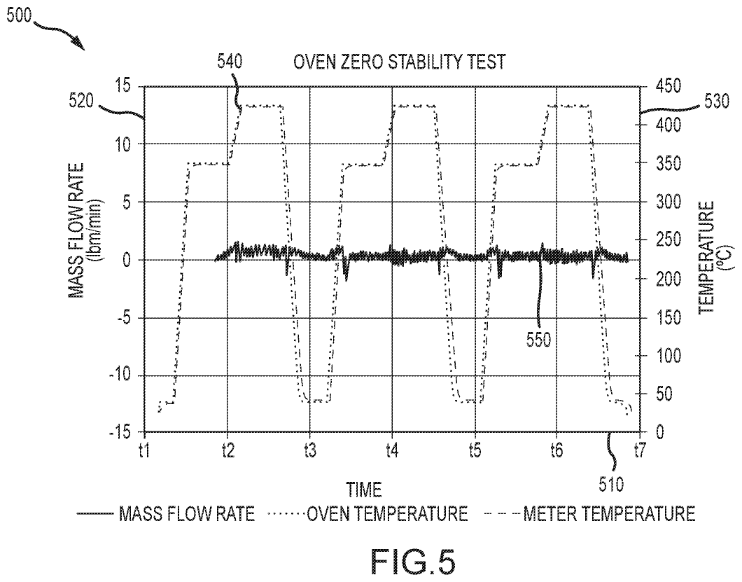

FIG. 5 shows a graph 500 illustrating stable mass flow rate measurements resulting from a coil transducer for elevated temperatures. As shown in FIG. 5, the graph 500 includes a time axis 510, a mass flow rate axis 520, and a temperature axis 530. The time axis 510 is shown in units of time, the mass flow rate axis 520 is shown as being in units of pound-mass per minute (lbm/min), and the temperature axis 530 is shown in units of degrees Celsius (° C.), although any suitable units may be employed.

The graph 500 includes temperature plots 540 (comprising oven temperature and meter temperature measurements) and a mass flow rate plot 550. The temperature plots 540 are shown as ranging from about 20° C. to about 430° C., although any suitable temperature ranges may be employed, including temperatures less than 20° C. and greater than 430° C. The mass flow rate plot 550 is shown as ranging from about −2 to about 2 lbm/min. The mass flow rate plot 550 is obtained by measuring a mass flow rate of a vibratory meter under zero-flow conditions. By comparing the temperature plots 540 and the mass flow rate plot 550, one can appreciate that the mass flow rate plot 550 does not change significantly when the temperature increases to 430° C., in contrast to the graph 400 shown in FIG. 4.

The stable mass flow rate measurements may be due to a bobbin that does not conduct at temperatures greater than 350° C. For example, the bobbin used in the vibratory meter tested to generate the graph 500 may be comprised of Macor, which is discussed above. The graph 500 shows that the bobbin comprised of Macor can ensure that a coil may have a repeatable electrical property of the temperature range of 20° C. to 430° C. However, as can be seen, three temperature cycles are shown. Accordingly, the effective operating limit of up to 430° C. is only proven for three temperature cycles. Some vibratory meters, such as the vibratory meter 5 described above, may require that the electrical properties be repeatable over many temperature cycles.

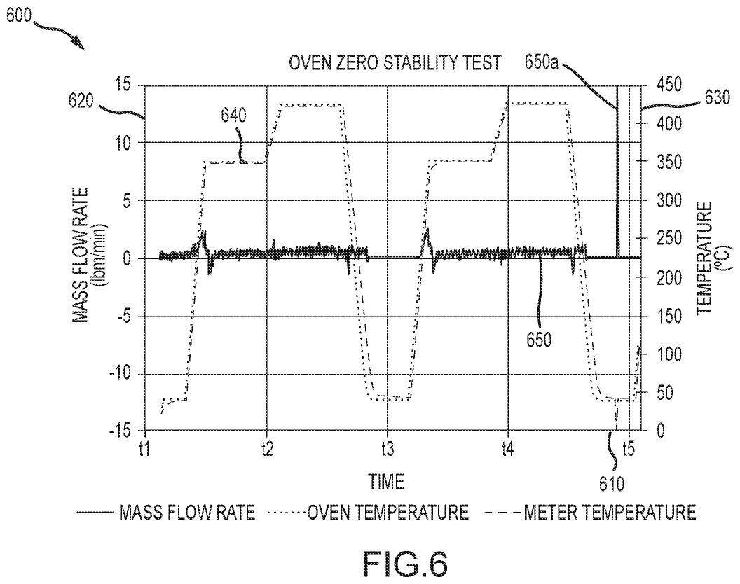

FIG. 6 shows a graph 600 illustrating a failure during temperature cycling that includes the elevated temperatures. As shown in FIG. 6, the graph 600 includes a time axis 610, a mass flow rate axis 620, and a temperature axis 630. The time axis 610 is shown in units of time, the mass flow rate axis 620 is shown as being in units of pound-mass per minute (lbm/min), and the temperature axis 630 is shown in units of degrees Celsius (° C.), although any suitable units may be employed.

The graph 600 includes temperature plots 640 (comprised of an oven temperature and a meter temperature) and a mass flow rate plot 650. The temperature plots 640 are shown as ranging from about 20° C. to about 430° C., with a negative going spike to 0° C., although any suitable range may be employed, including temperature less than 20° C. and greater than 430° C. The mass flow rate plot 650 is shown as ranging from about −2 to about 2 lbm/min, with a positive going spike to 15 lbm/min. By comparing the temperature plots 640 and the mass flow rate plot 650, one can appreciate that the mass flow rate plot 650 does not change significantly when the temperature plots 640 increase, in contrast to the graph 400 shown in FIG. 4. However, in contrast to the graph 500 shown in FIG. 5, the mass flow rate plot 650 also includes a flow rate spike 650a.

The flow rate spike 650a may be due to a failure in the conductive wire of the coil transducer in the tested vibratory meter. For example, the failure may have been a break, thereby causing an electrical open, in the conductive wire of the coil. As a result, the meter electronics was no longer receiving a signal, which was interpreted as a spike in the mass flow rate, indicated by the flow rate spike 650a. This failure shows that, although the bobbin and the conductive wire had repeatable electrical properties over the temperature range of up to 430° C., the conductive wire did not have repeatable electrical properties after two temperature cycles. The conductive wire may have been comprised of silver. The failure may have been due to mechanical creep of the silver wire.

Accordingly, literature review and/or other testing may suggest materials and/or design being selected for the conductive wire and/or electrical insulator to establish a coil that has repeatable electrical properties over a temperature range that is greater than 350° C., but that have repeatable electrical properties over a plurality of temperature cycles including the temperature range. For example, literature review may indicate that pure platinum may fail after a similar or fewer number of temperature cycles than silver (e.g., platinum has a lower yield strength than silver). However, other materials, such as platinum-rhodium may not experience such failures.

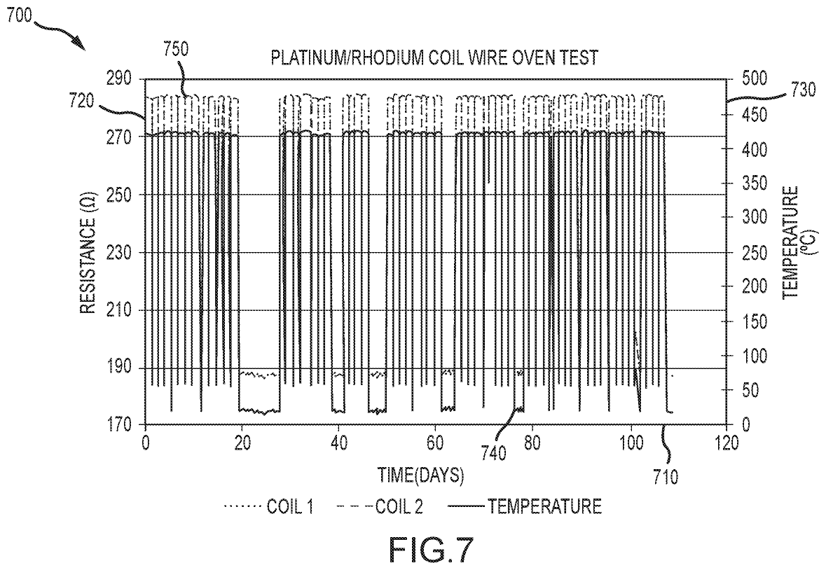

FIG. 7 shows a graph 700 illustrating resistance measurements resulting from a coil transducer for elevated temperatures. As shown in FIG. 7, the graph 700 includes a time axis 710, a resistance axis 720, and a temperature axis 730. The time axis 710 is shown in units of days, the resistance axis 720 is shown as being in units of ohms (a), and the temperature axis 730 is shown in units of degrees Celsius (° C.), although any suitable units may be employed. As is indicated in the graph 700, the conductive wire is comprised of the platinum-rhodium alloy.

The graph 700 includes a temperature plot 740 and resistance plots 750 (comprising measured resistances of a first and second coil). The temperature plot 740 is shown as ranging from about 20° C. to about 430° C., although any suitable range may be employed, including temperatures less than 20° C. and greater than 430° C. The resistance plots 750 range from about 188 ohms to about 285 ohms. The resistance plots 750 show that the resistances of the first and second coils are repeatable over the entire temperature range of 20° C. to 430° C. The resistance plots 750 also show that the resistance is repeatable (without failure) over a plurality of temperature cycles that include the elevated temperature range of 350° C. to 430° C. That is, the conductive wire comprising the platinum-rhodium alloy has a repeatable electrical property over the plurality of temperature cycles.

As can be appreciated, the repeatability of an electrical property can be associated with the temperature being increased or being decreased. For example, a resistance of the platinum-rhodium alloy at, for example, 400° C. may be different depending on whether the temperature was increased to 400° C. or decreased to 400° C.

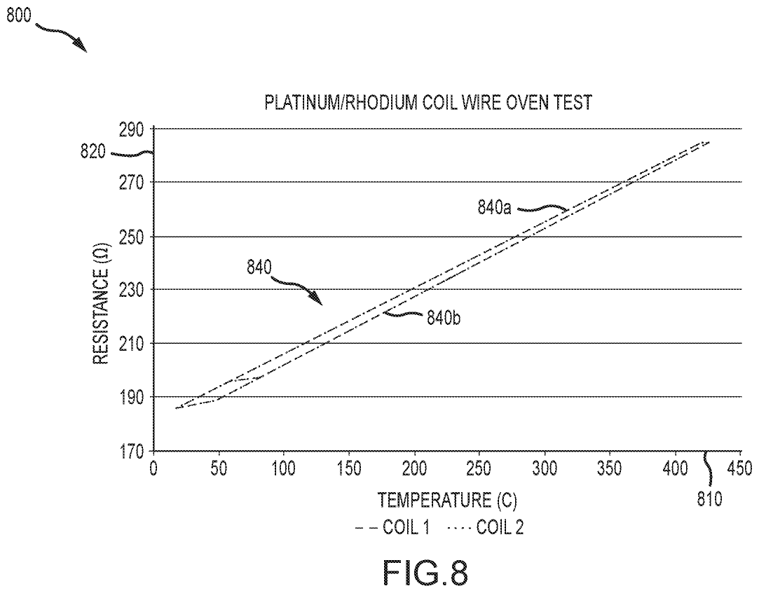

FIG. 8 shows a graph 800 illustrating electrical properties of a coil transducer for elevated temperatures. As shown in FIG. 8, the graph 800 includes a temperature axis 810 and a resistance axis 820. The temperature axis 810 is shown in units of degrees Celsius (° C.) and the resistance axis 820 is shown as being in units of ohms (a), although any suitable unit may be employed.

The graph 800 also includes hysteresis plots 840 (comprising measured resistances of the first coil and the second coil) showing the measured resistances of the first and second coils. The hysteresis plots 840 range from about 185 ohms to about 285 ohms over a temperature range of about 20° C. to about 430° C. The hysteresis plots 840 show that the resistances of the first and second coils increases as the temperature of the first and second coils increases.

As can also be seen, the hysteresis plots 840 include a first temperature path 840a and a second temperature path 840b. The first temperature path 840a may be the resistances measured as the temperatures of the first and second coil are decreased from about 430° C. to about 20° C. The second temperature path 840b may be the resistances measured as the temperature of the first and second coils are increased from about 20° C. to about 430° C. As can be seen, even though the resistances at a given temperature differ depending on which of the first and second temperature paths 840a, 840b is measured, the resistance values are still repeatable over the temperature range.

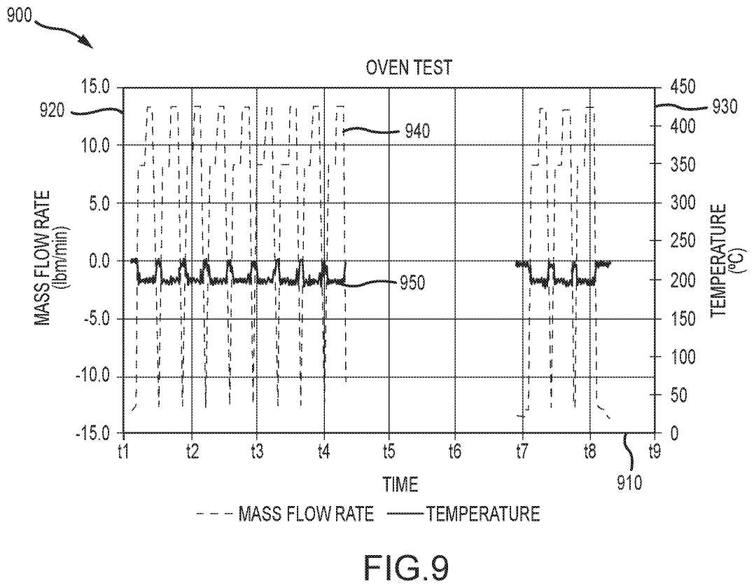

FIG. 9 shows a graph 900 illustrating stable mass flow rate measurements resulting from a coil transducer for elevated temperatures. The coil transducer may be comprised of the platinum-rhodium alloy conductive wire described with reference to FIGS. 7 and 8. As shown in FIG. 9, the graph 900 includes a time axis 910, a mass flow rate axis 920, and a temperature axis 930. The time axis 910 is shown in units of time, the mass flow rate axis 920 is shown as being in units of pound-mass per minute (lbm/min), and the temperature axis 930 is shown in units of degrees Celsius (° C.), although any suitable units may be employed.

The graph 900 includes a temperature plot 940 and a mass flow rate plot 950. The temperature plot 940 and the mass flow rate plot 950 include gaps where testing was paused. The temperature plot 940 is shown as ranging from about 20° C. to about 430° C., although any suitable range may be employed, including temperature less than 20° C. and greater than 430° C. The mass flow rate plot 650 is shown as ranging from about 0 to about −2 lbm/min. By comparing the temperature plot 640 and the mass flow rate plot 650, one can appreciate that the mass flow rate plot 650 does not change significantly when the temperature plot 640 increases. As can also be appreciated, the mass flow rate plot 650 remains about zero lbm/min over a plurality of temperature cycles.

### Method of Forming a Coil Transducer

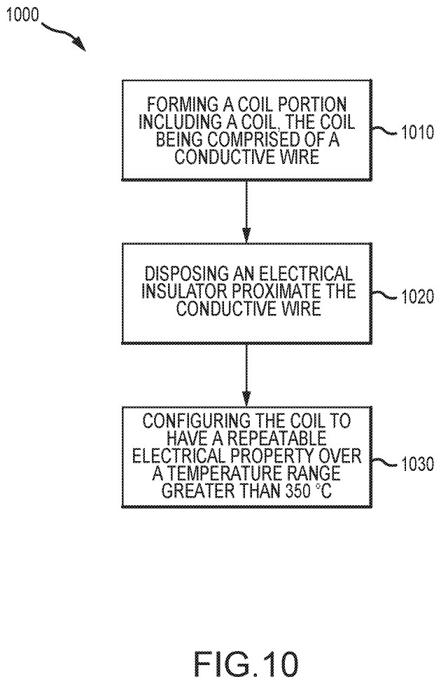

FIG. 10 shows a method 1000 of forming a coil transducer for elevated temperatures. The method 1000 forms a coil portion that includes a coil in step 1010. The coil may be comprised of a conductive wire. In step 1020, the method 1000 disposes an electrical insulator proximate the conductive wire. The method 1000, in step 1030, configures the coil to have a repeatable electrical property over a temperature range that is greater than 350° C. The temperature range may, for example, be from 350° C. to 500° C., from 350° C. to 427° C., from 410° C. to 500° C., and/or from 410° C. to 427° C.

In step 1030, the method 1000 may configure the coil to have the repeatable electrical property over the temperature range that is greater than 350° C. by configuring the conductive wire and the electrical insulator to be thermal-expansion compatibles of each other over the temperature range. Additionally or alternatively, the method 1000 may configure the electrical insulator to be substantially non-conductive over the temperature range. Additionally or alternatively, the method 1000 may configure the conductive wire to have a substantially repeatable conductivity over the temperature range.

The method 1000 may configure the conductive wire and the electrical insulator to be thermal-expansion compatibles of each other by configuring the conductive wire and the electrical insulator to have substantially equal coefficients of thermal expansion. The substantially equal coefficients of thermal expansions may be determined by, for example, comparing coefficients of thermal expansions available from data sheets. Additionally, the design and manufacturing of the conductive wire and the electrical insulator(s), such as their respective shapes, dimension, construction, etc., may also be considered to determine if the coefficients of thermal expansions are substantially equal. For example, a conductive wire wound around a bobbin may have substantially the same coefficients of thermal expansion if the wire is relatively short and wound with relatively low tensions but not have substantially the same coefficients of thermal expansion if the conductive wire is relatively long and wound with relatively high tensions.

The method 1000 may configure the conductive wire to have a substantially repeatable conductivity over the temperature range by configuring the conductive wire to have a substantially repeatable conductivity over a plurality of temperature cycles including at least a portion of the temperature range. The method 1000 may configure the conductive wire in such a way by selecting and forming the conductive wire, with or without the electrical insulator, and, for example, testing the conductive wire as described above with reference to FIGS. 7-9. As discussed above with reference to FIGS. 2-9, each of the plurality of temperature cycles employed in the method 1000 may include the temperature range.

The method 1000 may dispose the electrical insulator proximate the conductive wire by disposing a ceramic coating on the conductive wire. Additionally or alternatively, the method 1000 may dispose the electrical insulator proximate the conductive wire by forming a bobbin and disposing the coil around the bobbin. Accordingly, the method 1000 may configure the conductive wire and the electrical insulator to be thermal-expansion compatibles of each other by configuring the conductive wire and at least one of the bobbin and the ceramic coating to be thermal-expansion compatibles of each other.

The method 1000 may employ various materials. For example, the conductive wire may comprise a magnetic material. Additionally or alternatively, the conductive wire comprises a material that includes one of nickel, a platinum-rhodium alloy, a platinum-iridium alloy, and a niobium-tantalum-tungsten alloy. The method 1000 may also form a magnet portion and configuring the magnet portion to spatially displace relative to the coil portion.

The above disclosed coil transducer 200 and method 1000 for forming the coil transducer can be used to provide the vibratory meter 5 with a stable zero-flow offset at the elevated temperatures. The stable zero-flow offset can be achieved at the elevated temperatures by including the coil 212 being configured to have a repeatable electrical property over the temperature range that is greater than 350° C. This technical advantage of the stable electrical property over the temperature range allows, for example, the meter electronics 20 to accurately correlate the mechanical displacement of the at least one conduit 103A, 103B to the electrical signal in the coil transducer 200 to achieve the technical effect of the stable zero-flow offset thereby ensuring accurate measurements, such as mass flow rate measurements, at the elevated temperatures. Additionally or alternatively, meter verification may be performed where conditions, such as coatings, cracks, erosions, or the like, in the conduit(s) may be accurately detected.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other coil transducers for elevated temperatures and not just to the embodiments described above and shown in the accompanying figures. Accordingly, the scope of the embodiments described above should be determined from the following claims.

1. A coil transducer (200) for elevated temperatures, the coil transducer (200) comprising:
a coil portion (210) including a coil (212), the coil (212) being comprised of a conductive wire (212a); and
an electrical insulator disposed proximate the conductive wire (212a);
wherein the coil (212) is configured to have a repeatable electrical property over a temperature range that is greater than 350° C.

2. The coil transducer (200) of claim 1, wherein the coil (212) being configured to have the repeatable electrical property over the temperature range that is greater than 350° C. comprises at least one of:
the conductive wire (212a) and the electrical insulator being thermal-expansion compatibles of each other over the temperature range;
the electrical insulator being substantially non-conductive over the temperature range; and
the conductive wire (212a) having a substantially repeatable conductivity over the temperature range.

3. The coil transducer (200) of claim 2, wherein the conductive wire (212a) and the electrical insulator being thermal-expansion compatibles of each other comprises the conductive wire (212a) and the electrical insulator having substantially equal coefficients of thermal expansion.

4. The coil transducer (200) of claim 2, wherein the conductive wire (212a) having a substantially repeatable conductivity over the temperature range comprises the conductive wire (212a) having a substantially repeatable conductivity over a plurality of temperature cycles including at least a portion of the temperature range.

5. The coil transducer (200) of claim 4, wherein each of the plurality of temperature cycles includes the temperature range.

6. The coil transducer (200) of claim 1, wherein the electrical insulator comprises a ceramic coating (212b) on the conductive wire (212a).

7. The coil transducer (200) of claim 1, wherein the electrical insulator comprises a bobbin (214), and the coil (212) is disposed around the bobbin (214).

8. The coil transducer (200) of claim 7, wherein the conductive wire (212a) and at least one of the bobbin (214) and the ceramic coating (212b) are thermal-expansion compatibles of each other.

9. The coil transducer (200) of claim 1, wherein the conductive wire (212a) comprises a magnetic material.

10. The coil transducer (200) of claim 1, wherein the conductive wire (212a) comprises a material that includes one of nickel, a nickel alloy, a platinum-rhodium alloy, a platinum-iridium alloy, and a niobium-tantalum-tungsten alloy.

11. The coil transducer (200) of claim 1, wherein the temperature range is one of from 350° C. to 500° C., from 350° C. to 427° C., from 410° C. to 500° C., and from 410° C. to 427° C.

12. The coil transducer (200) of claim 1, further comprising a magnet portion (220), the magnet portion (220) being configured to spatially displace relative to the coil portion (210).

13. A method of forming a coil transducer for elevated temperatures, the method comprising:
forming a coil portion including a coil, the coil being comprised of a conductive wire;
disposing an electrical insulator proximate the conductive wire; and
configuring the coil to have a repeatable electrical property over a temperature range that is greater than 350° C.

14. The method of claim 13, wherein configuring the coil to have the repeatable electrical property over the temperature range that is greater than 350° C. comprises at least one of:
configuring the conductive wire and the electrical insulator to be thermal-expansion compatibles of each other over the temperature range;
configuring the electrical insulator to be substantially non-conductive over the temperature range; and
configuring the conductive wire to have a substantially repeatable conductivity over the temperature range.

15. The method of claim 14, wherein configuring the conductive wire and the electrical insulator to be thermal-expansion compatibles of each other comprises configuring the conductive wire and the electrical insulator to have substantially equal coefficients of thermal expansion.

16. The method of claim 14, wherein configuring the conductive wire to have a substantially repeatable conductivity over the temperature range comprises configuring the conductive wire to have a substantially repeatable conductivity over a plurality of temperature cycles including at least a portion of the temperature range.

17. The method of claim 16, wherein each of the plurality of temperature cycles includes the temperature range.

18. The method of claim 13, wherein disposing the electrical insulator proximate the conductive wire comprises disposing a ceramic coating on the conductive wire.

19. The method of claim 13, wherein disposing the electrical insulator proximate the conductive wire comprises forming a bobbin and disposing the coil around the bobbin.

20. The method of claim 19, wherein configuring the conductive wire and the electrical insulator to be thermal-expansion compatibles of each other comprises configuring the conductive wire and at least one of the bobbin and the ceramic coating to be thermal-expansion compatibles of each other.

21. The method of claim 13, wherein the conductive wire comprises a magnetic material.

22. The method of claim 13, wherein the conductive wire comprises a material that includes one of nickel, a nickel alloy, a platinum-rhodium alloy, a platinum-iridium alloy, and a niobium-tantalum-tungsten alloy.

23. The method of claim 13, wherein the temperature range is one of from 350° C. to 500° C., from 350° C. to 427° C., from 410° C. to 500° C., and from 410° C. to 427° C.

24. The method of claim 13, further comprising forming a magnet portion and configuring the magnet portion to spatially displace relative to the coil portion.

25. A vibratory meter (5) for elevated temperatures, the vibratory meter (5) comprising:
a meter electronics (20);
a meter assembly (10) communicatively coupled to the meter electronics (20), the meter assembly (10) comprising:
at least one conduit (103A, 103B);
a driver (104) coupled to the at least one conduit (103A, 103B); and
at least one pickoff (105, 105′) coupled to the at least one conduit (103A, 103B);
wherein at least one of the driver (104) and the at least one pickoff (105, 105′) comprise a coil transducer (200), the coil transducer (200) comprising:
a coil portion (210) including a coil (212), the coil (212) being comprised of a conductive wire (212a); and
an electrical insulator disposed proximate the conductive wire (212a);
wherein the coil (212) is configured to have a repeatable electrical property over a temperature range that is greater than 350° C.

26. The vibratory meter (5) of claim 25, wherein the coil (212) being configured to have the repeatable electrical property over the temperature range that is greater than 350° C. comprises at least one of:
the conductive wire (212a) and the electrical insulator being thermal-expansion compatibles of each other over the temperature range;
the electrical insulator being substantially non-conductive over the temperature range; and
the conductive wire (212a) having a substantially repeatable conductivity over the temperature range.
